(19) United States
(12) Patent Application Publication
(10) Pub. No.: US 2007/0028768 A1
(43) Pub. Date: Feb. 8, 2007

(54) Method of adsorption using self-locking carbon adsorbent

(76) Inventors: Sumio Iijima, Nagoya-shi (JP); Masako Yudasaka, Tsukuba-shi (JP); Katsuyuki Murata, Tsukuba-shi (JP); Katsumi Kaneko, Ichihara-shi (JP); Daisuke Kasuya, Kashiwa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/543,955

(22) Filed: Oct. 6, 2006

Related U.S. Application Data
(62) Division of application No. 10/517,830, filed on Jun. 30, 2005.

(30) Foreign Application Priority Data
Jun. 18, 2002 (JP) 2002-177656

(51) Int. Cl. B01D 53/02

(52) U.S. Cl. 95/90

(57) ABSTRACT

Methane or hydrogen are adsorbed by passing the substance through one or more openings provided in a wall part of a carbon-nanohorn aggregate. The carbon-nanohorn aggregate forms a self-locking carbon adsorbent. The substance passes through the one or more openings in one limited direction from the outside to the inside of the carbon nanohorn aggregate in isothermal or isobaric adsorption.

This is a Divisional Application of U.S. patent application Ser. No. 10/517,830, filed Jun. 30, 2005, which was the National Stage of International Application No. PCT/JP02/07967, filed Aug. 5, 2002.

### TECHNICAL FIELD

The invention relates to a self-locking carbon adsorbent, particularly to a new self-locking carbon adsorbent which is useful for storing methane gas and can store various gases put in a high density as quasi-liquid state at room temperature.

### BACKGROUND ART

Much attention is focused on natural gas as clean energy which takes the place of petroleum oil from the viewpoint of preservation of the global environment and effective utilization of resources. The density of methane gas, which is a major component of natural gas, is 23 g/L at 303 K under 3.5 MPa, but is as very high as 419 g/L at its boiling point or 109 K. Liquefied natural gas is, based on this characteristic, cooled under pressure to liquefy after it is refined into a methane component as a major component and supplied as highly refined liquefied natural gas called refrigerated liquid methane (RLM).

However, this liquefied natural gas has the drawback that it must be kept at an extreme low temperature as low as −160° C. or less, during all processes such as storage and transfer and therefore has difficulty being put to practical use. In this situation, expectations are to develop a methane storing system capable of storing a large amount of methane at room temperature.

For example, the U.S. Department of Energy (DOE) is trying to realize a storage unit of methane gas at room temperature with the aim of achieving a methane storing rate of 150 times per unit volume (V/Vs: V represents the volume of gas to be adsorbed and Vs represents the volume of an adsorbent) under a pressure of 500 psig (about 3.5 MPa) by utilizing an activated carbon which is a porous solid as a methane adsorbent.

The methane storing rate of activated carbon is approaching such a value as high as 150 times which is the target of DOE. However, this target has not been achieved yet. The reason is considered to be that methane gas is not liquefied at room temperature even if it is placed in an extreme pressure state because it takes a supercritical state.

The present invention has been made in view of the above situation, and it is an object of the invention to solve the prior art problems and to provide a new self-locking carbon adsorbent which is useful for storing methane gas and can store various gases at a high density in a quasi-liquid state at room temperature.

### SUMMARY OF THE INVENTION

Accordingly, the present invention provides the following to solve the aforementioned problem.

Specifically, the present invention provides, first, a self-locking carbon adsorbent comprising a carbon nanohorn aggregate provided with one or more openings in the wall part thereof, wherein a substance to be adsorbed passes through the opening in one limited direction from the outside to inside of the carbon nanohorn in isothermal or isobaric adsorption.

With regard to the method of the above invention, the present invention provides, second, a self-locking carbon adsorbent wherein the substance to be adsorbed is gas which is put in a supercritical state at room temperature, third a self-locking carbon adsorbent wherein the substance to be adsorbed is methane gas and the methane gas is allowed to be adsorbed in a quasi-liquid state on the inside of the carbon nanohorn, and fourth a self-locking carbon adsorbent wherein the methane gas adsorption ability V/Vs (where V represents the volume of gas to be adsorbed and Vs represents the volume of an adsorbent) is 150 or more at 303 K under 3.5 MPa.

The inventors of the present invention have made studies toward realizing a high performance adsorbent using a carbon nanohorn aggregate and have already found that the carbon nanohorn aggregate has adsorption ability and that the adsorption capacity is increased and a molecular sieve can be realized by providing an opening in the horn part of the carbon monohorn aggregate. Further, the present invention has been attained by finding, for the first time, that a carbon nanohorn aggregate having an opening exhibits very specific characteristics when storing (occluding) methane gas as a result of further earnest studies made by the inventors.

### BRIEF DESCRIPTION OF DRAWINGS

FIGS. 1(a) to 1(d) are a TEM image and typical views for explaining the structure of a self-locking carbon adsorbent according to the present invention.

FIG. 2 is a typical view for explaining a self-lock mechanism in a self-locking carbon adsorbent according to the invention.

FIG. 3 is a view illustrating the methane adsorption character of a SWNH, opened SWNH, ACF and AX21.

FIG. 4 is a view illustrating the average density of methane adsorbed to the internal pores and voids of an opened SWNH, ACF, AX21 and bulk activated carbon.

FIGS. 5(a) to 5(d) are views illustrating each pore structure of an opened SWNH, ACF and AX21 and the potential of the interaction between a methane molecule and a carbon wall.

FIG. 6 is a view illustrating hydrogen adsorption character of an opened SWNH and its theoretical value.

### BEST MODE FOR CARRYING OUT THE INVENTION

The present invention has the characteristics as mentioned above. An embodiment of the invention will be hereinafter explained.

A self-locking carbon adsorbent comprises a carbon nanohorn aggregate provided with one or more openings in its wall part thereof, wherein a substance to be adsorbed passes through the opening in one limited direction from the outside to the inside of the carbon nanohorn in isothermal or isobaric adsorption.

As the carbon nanohorn aggregate in the invention of the patent application, various carbon nanohorn aggregates provided with one or more openings in at least one of their tube walls, among carbon nanohorn aggregates in which carbon nanohorns that are carbon nanotubes having a horn-like end and many carbon nanohorns are aggregated spherically with their ends protruding externally, may be the subject. Any of, for example, dahlia-like carbon nanohorn aggregates in which carbon nanohorns are gathered in a globular form 80 to 100 nm in diameter and bud-like carbon nanohorn aggregates which are not provided with a surface on which horn-like projections are observed but provided with a smooth surface may also be used. In order to realize a highly efficient and high performance adsorbent, the carbon nanohorn aggregate is preferably a dahlia-like carbon nanohorn aggregate provided with one or more openings. The carbon nanohorn aggregate may be constituted of a single carbon nanohorn aggregate or plural carbon nanohorn aggregates put in a dispersed state or aggregated state.

In the present invention, there is no particular limitation to the number or size of the openings disposed in the wall of the carbon nanohorn, and carbon nanohorn aggregates having optional number and size of openings according to the size of an adsorbed material may be used. For example, when the substance to be adsorbed is methane (molecular diameter: 0.37 nm), more preferable examples of the aggregate are given in which the size of the opening is 0.37 nm or more at least, and more preferably the diameter of the aggregates is 0.7 to 1.1 nm corresponding to about two or three molecules. Such openings are considered to be preferably present in relatively small numbers only in the wall part of the carbon nanohorn.

The self-locking carbon adsorbent of the invention of the patent application like this is provided with an opening in the wall part of a carbon nanohorn and therefore has, as an adsorption space, interstices between individual carbon nanohorns constituting the carbon nanohorn aggregate and the inner parts of these carbon nanohorns. When plural carbon nanohorn aggregates are aggregated to constitute the self-locking carbon adsorbent, the self-locking carbon adsorbent also has spaces formed between neighboring carbon nanohorn aggregates as adsorption capacity.

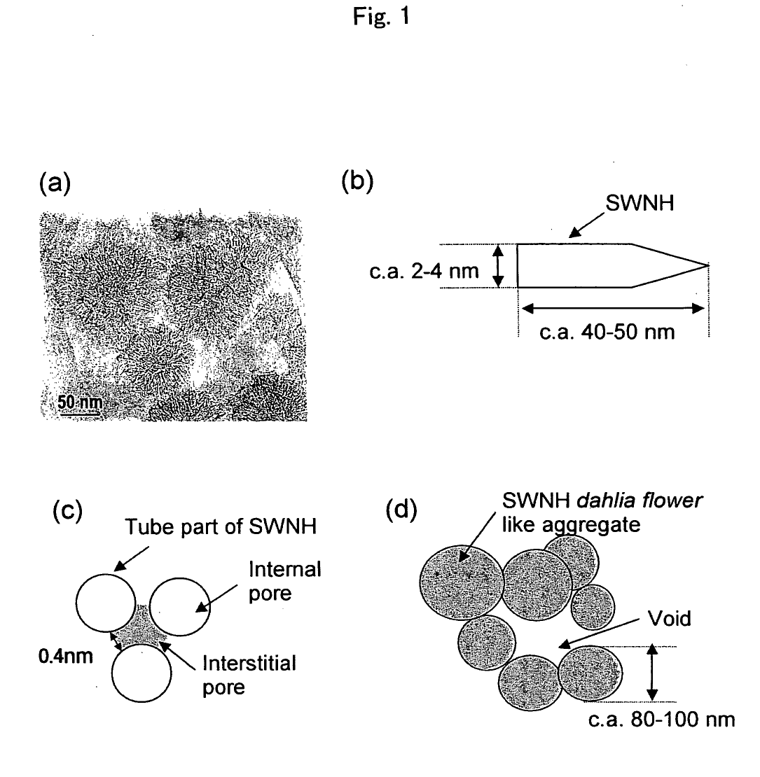

The self-locking carbon adsorbent will be explained in more detail with reference to FIG. 1. For example, the self-locking carbon adsorbent of the invention as shown in (a) is one in which average dahlia-like carbon nanohorn aggregates are aggregated. A single dahlia-like carbon nanohorn aggregate is a globular body having a diameter of about 80 to 100 nm. As shown in (b), in an example of one carbon nanohorn constituting this globular body, the diameter of the tube part is about 2 to 4 nm with a length of about 50 nm. In this dahlia-like carbon nanohorn aggregate, the distance between each tube part of neighboring carbon nanohorns is about 0.4 nm as shown in (c). In the self-locking carbon adsorbent like this, the wall part is provided with an opening and therefore, interstitial pores formed in interstices between adjacent carbon nanohorns, internal pores on the inside of carbon nanohorns and further, voids formed between aggregated dahlia-like carbon nanohorn aggregates as shown in (d) may also be utilized as adsorption capacity.

No particular limitation is imposed on the substance to be adsorbed and various gases, such as nitrogen, methane, hydrogen and the like, which are put in a supercritical state at room temperature, may be considered. Methane may be exemplified as the substance to be adsorbed which substance can use the characteristics of the self-locking carbon adsorbent of the invention of the patent application more efficiently.

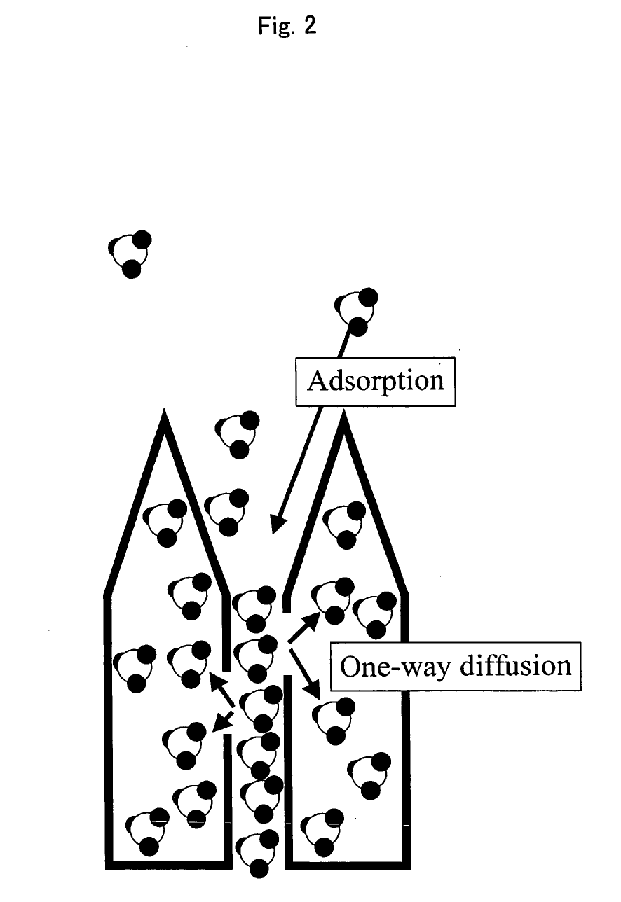

To state the features of this self-locking carbon nano-adsorbent, the distance between each tube part of individual carbon nanohorns constituting the carbon nanohorn aggregate is as narrow as about 0.4 nm as mentioned above and therefore, a micropore phenomenon takes place in the interstices between carbon nanohorns. When a sufficient amount of a substance to be adsorbed is supplied, the substance to be adsorbed is fed to the inside of nanohorns through interstices between individual carbon nanohorns and the openings. At this time, the substance to be adsorbed is filled in the interstices between carbon nanohorns as illustrated in FIG. 2. Therefore, even if the substance to be adsorbed can enter the inside of the carbon nanohorns through the openings, it cannot be going out from the inside of the carbon nanohorn to the outside. Namely, in adsorption under a condition such as an isothermal or isobaric condition, where no external force acts, the substance to be adsorbed passes through the opening in one limited direction from the outside to inside of the carbon nanohorn.

When the substance to be adsorbed is methane gas, methane gas is initially adsorbed at a low density inside of the carbon nanohorn. It is amazing that when methane gas is supplied in a sufficient concentration to the inside of the carbon nanohorn, it is condensed into a quasi-liquid state by the interaction between methane gas and the wall of the carbon nanohorn on the inside of the nanohorn. Here, the quasi-liquid state is a state of gas such that the density of the gas reaches that of a liquid under low pressures in a supercritical state. Here, the term “low pressure” cannot be shown in detail because it differs depending on the type and temperature of gas. However, it is about a so-called critical pressure and, is, for example, about 4.7 MPa in the case of methane gas. Such a quasi-liquid state has been confirmed at an extreme low temperature in the vicinity of, for example, the boiling point of methane gas. Meanwhile, in the self-locking carbon adsorbent of the invention, the quasi-liquid state is achieved at a temperature in the vicinity of room temperature, which is very high for liquid methane, which is regarded as a specific phenomenon.

In the invention, the quasi-liquid state methane means high density methane having a density of 0.26 to 0.31 g/L at 303 K as was reported by Dubinin at al., and Ozawa et al., (R. K. Agarwal, J. A. Schwarz, Carbon 26,873 (1988)). To exemplify in more detail, it has been confirmed that the self-locking carbon adsorbent of the invention can attain a methane gas adsorption ability of 150 or more in the condition of 303 K and 3.5 MPa when the methane gas adsorption ability is expressed by V/Vs. This adsorption ability value is higher by about 10% than the DOE target value, which suggests that those results will lead to the realization of a storage unit of methane gas having high performance. In the above formula, V represents the volume of the gas to be adsorbed and Vs represents the volume of the adsorbent. Moreover, it is expected, though not confirmed, that repeated improvements using the self-locking carbon adsorbent of the invention of the patent application enables a large amount of methane to be stored in a more thickened state than liquid methane (density: 0.31 g/L).

The self-locking carbon adsorbent like this according to the invention is expected to be applied to storage materials in fuel cylinders for fuel cells that are expected to be utilized in various fields in the future.

Embodiments of the invention will be explained in detail by way of examples and with reference to drawings.

### EXAMPLES

### Example 1

The isothermal adsorption characteristic of a dahlia-like carbon nanohorn (SWNH), carbon nanohorn (opened SWNH) provided with openings on the tube wall or the tip part of the above dahlia-like carbon nanohorn by oxidation heating treatment, activated carbon fiber (ACF) and KOH activated carbon (AX21) were measured. Prior to the measurement, the SWNH and the opened SWNH were treated under heating at 423 K under a pressure of 1 mPa to remove adsorbed gas and moisture.

The methane adsorption characteristic of the SWNH, opened SWNH, ACF and AX21 were measured at 303 K under a pressure range from 10 kPa to 10 MPa by utilizing an electronic balance. The interstitial pore structures of these materials were estimated from N2 adsorption isotherm at 77 K by utilizing a SPE method (subtracting pore effect method) which subtracts the effect of fine pores. Moreover, with regard to the correlation characteristic between CH₄ and the SWNH, that of the interstitial pore and the internal pore were calculated by utilizing the Steele-Bojan smooth-walled cylinder potential. Then, the correlation characteristic of the slit-type pore which conventional activated carbon possesses was calculated using the 10-4-3 potential of Steele.

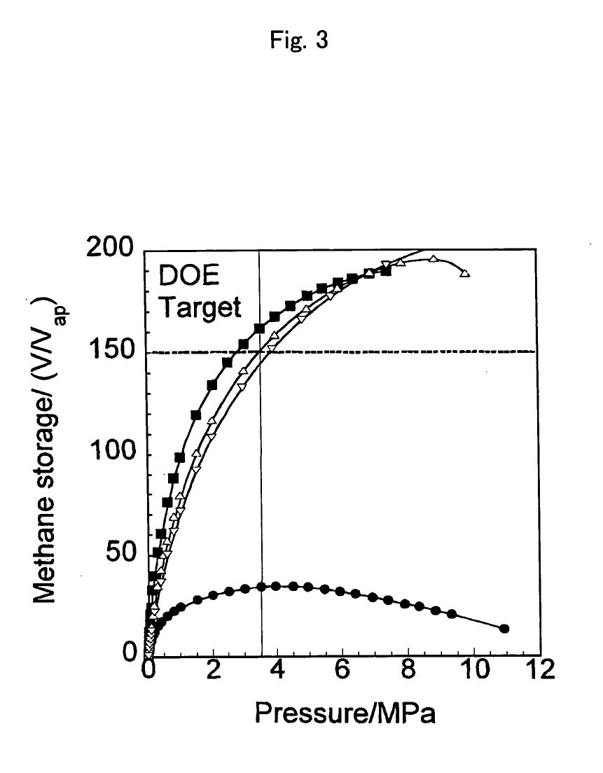

FIG. 3 shows the methane storing ability of each material. In the FIG., ●, ▪, Δ and ∇ indicate the SWNH, opened SWNH, ACF and AX21 respectively. In V/Vap showing methane storing ability in the FIG., Vap is a value obtained by subtracting the volume of all fine pores from the volume of a material and V is the volume of a solid including fine pores wherein V is always larger than Vap.

It is confirmed from FIG. 3 that as regards methane storing, the methane storing ability of the SWNH itself is low whereas the opened SWNH can attain a methane gas storing rate as high as 150 times (V/Vs) per unit solid volume, which is the target value of DOE, under a pressure of 4 MPa.

It is found that each methane storing ability of ACF and AX21 is on a level less than 150 V/Vap even under a pressure range as high as 7 to 8 MPa. It is also found that the target value of DOE can be attained even if the pressure is raised. This is considered to be because AX 21 contains a large number of voids and a lot of a binder required to form a monolith structure and ACF contains a larger number of voids than AX21 because ACF is a fibrous material. On the other hand, the SWNH is a globular particle having a nano-dimension and forms a monolith structure without the necessity of a binder. Therefore, the opened SWNH obtained by forming openings in the SWNH is considered to be very effective for adsorbing and filling methane. The above fact in this example shows that only the opened SWNH can attain the target of DOE.

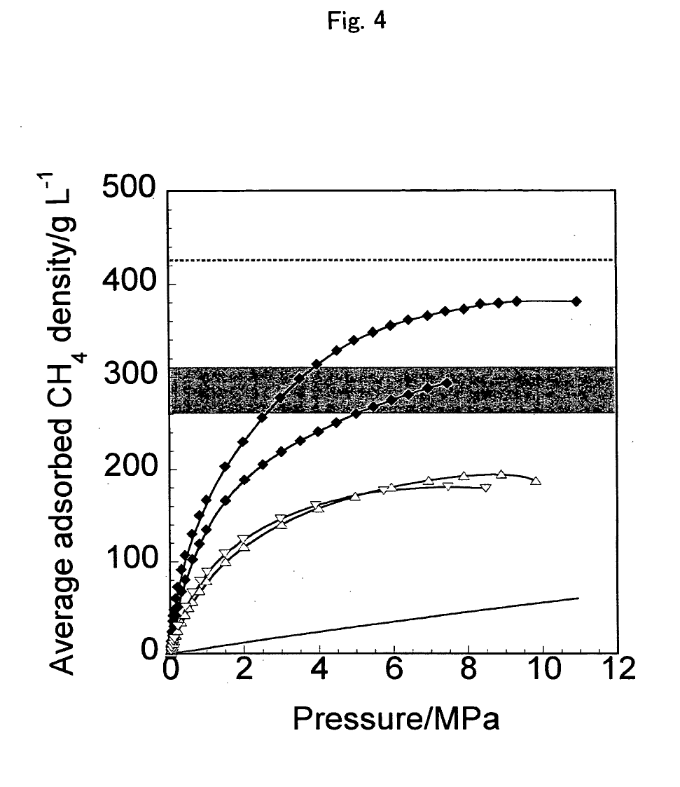

For this, the reason why the opened SWNH has a methane adsorption ability enough to attain the target of DOE will be discussed hereinbelow. It is considered that although methane is not usually liquefied at room temperature, the density of methane adsorbed to the opened SWNH becomes close to a level which stands comparison with that of liquid methane. FIG. 4 shows the average density of methane adsorbed to the inside of fine pores in each of the opened SWNH, ACF and AX21 at 303 K. In the FIG., the average density of methane adsorbed to each of the interstitial pores of the opened SWNH ( [symbol] ), the internal pores of the opened SWNH ( [symbol] ), the slit-form pores of ACF (Δ), the slit-form pores of AX21 (∇) and bulk activated carbon (−) are shown. Here, the average density ρad of methane is defined by n/VO-ρbulk. In the formula, n is the amount to be adsorbed, VO is the volume of fine pores and ρbulk is the density of a gas phase.

The average density of methane adsorbed to each of the interstitial pores and internal pores of the SWNH is 1.5 to 2 times larger than that of ACF or AX21. However, as this measuring temperature 303 K is higher than the critical temperature of methane, methane cannot be liquefied if it is compressed at 303 K. In the meantime, Dubinin et al., and Ozawa et al., have proposed that methane having a density range from 0.26 to 0.31 g/L shown by the band in FIG. 3 is placed in a quasi-liquid state. Namely, the density of methane to be adsorbed to this opened SWNH is in the range of the density of quasi-liquid methane at 303 K. Therefore, methane adsorbed to the internal pores of the SWNH is put in a quasi-liquid state under a pressure of 5 MPa or more even if the correlation potential of methane with the SWNH wall at the multilayer position is so small that it is not adsorbed (see FIG. 4 which will be explained later). It is understood that this is an extremely specific phenomenon taking it into account that methane is put in a supercritical state and cannot be compressed into a liquid state even under high pressure.

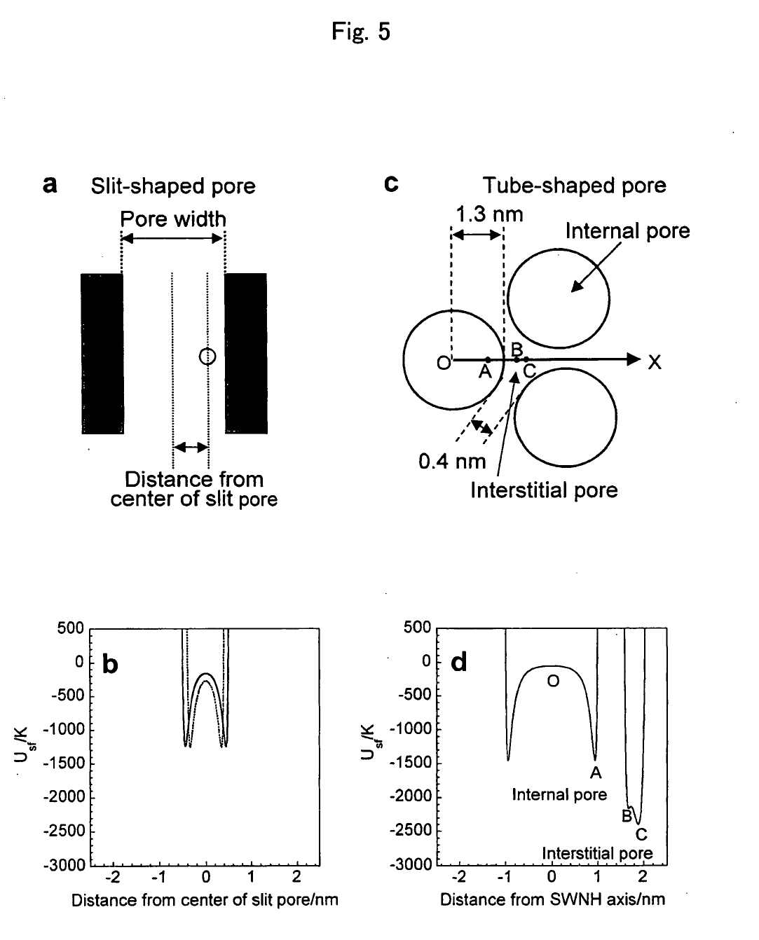

This specific phenomenon can be understood based on an interaction potential between a methane molecule and the carbon wall. FIGS. 5 (a) and 5(c) respectively show the structure of a pore and FIGS. (b) and (d) respectively show the correlation potential characteristic between carbon and methane. (a) and (b) show the slit-form pores of ACF and AX21 respectively and (c) and (d) show the tube-form pores in the SWNH (opened SWNH). Each X axis in (b) and (d) indicates the distance from the center of a pore to the wall of carbon and the distance from the O point to the X point respectively. In (b), the dotted line shows the potential characteristic of ACF and the solid line shows the potential characteristic of AX21. (d) shows the potential characteristic of the SWNH.

As shown in (b), the correlation potential depths between a methane molecule and the wall of carbon in ACF and AX21 were −1240 and −1250 K respectively. On the other hand, the fine pores of the SWNH (opened SWNH) are oriented so as to partly organize the order structure of a trigonal system. For this, each potential in these structures was calculated based on the formula 10-4-3 of Steel. Here, as the tube diameter and the distance between neighboring tubes in the SWNH, 2.8 nm and 0.4 nm which were found from the results of N2 adsorption isotherm were used respectively. As a result, the correlation potential depth between a methane molecule and the wall of carbon in the interstice and the inside of the SWNH were −2400 K and −1450 K respectively.

The results of the adsorption characteristic of methane to activated carbon or ACF were as follows. The regularity of adsorption amount corresponded to the regularity of each average potential depth and the amount of methane to be adsorbed accorded to the results of GCMC simulation and theoretical studies because these activated carbon and ACF both had slit-form pores.

However, the adsorption of methane to the opened SWNH was different from the above results. As shown in (d), the average potential depth (A) of the internal pores of the SWNH was smaller than that of the interstices (B) and (C) and it was therefore inferred that the density of methane adsorbed to the internal pores of the opened SWNH was also lower. However, from the results of FIG. 4, the density of methane in the internal pores of the opened SWNH must be equal to that in the interstice of the SWNH and be by far larger than each density of methane adsorbed to AX21 and ACF. Such inconsistency is well supported in theoretical studies and the theoretical density becomes lower than the actual results because methane in the tube is isolated.

From the above results, it may be considered that methane is concentrated at an extraordinarily high density inside of the pores by the self-lock mechanism shown in FIG. 2 in the opened SWNH, that is, the self-locking carbon adsorbent. Methane molecules adsorbed to interstitial pores are diffused to internal pores through the openings formed in the tube part. However, diffusion in the inverse direction is made impossible because it is blocked by methane molecules that have already existed outside of the openings. Namely, methane molecules are diffused in one direction only towards the internal pores.

This phenomenon is caused only by the narrow interstices formed with the tube part of carbon nanohorns, the openings formed in the tube part of carbon nanohorns and the specific structure of the carbon nanohorn aggregate which has a large capacity.

(Example 2)

The hydrogen adsorption characteristic of a carbon nanohorn (opened SWNH) provided with openings in the tube wall or the tip part by subjecting a dahlia-like carbon nanohorn to oxidation heat treatment were investigated. Prior to the measurement of adsorption, the opened SWNH was heat-treated at 423 K under a pressure of 1 mPa or less to remove adsorbed gas and moisture.

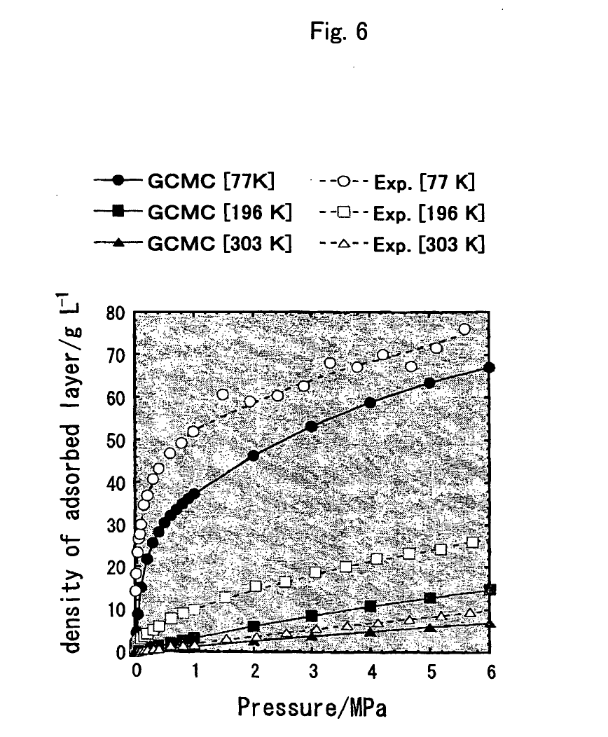

The hydrogen isothermal adsorption characteristic of the opened SWNH were measured using an electronic balance at three temperatures, 77 K, 196 K and 303 K, under a pressure ranging from 10 kPa to 10 MPa. The results are shown in FIG. 6.

Also, using a carbon tube having the same tube diameter, a simulation using a computer was carried out to estimate the amount of hydrogen to be stored theoretically and the results are also shown together. This theoretical estimation has been confirmed to conform to the amount to be stored in an experiment made for a carbon material having slit type pores sandwiched between plane carbons. In the simulation, a Grand Canonical Monte Carlo (GCMC) method was used. The correlation characteristic between CH₄ and the SWNH used in the GCMC method was calculated utilizing the Steel-Bojan smooth-walled cylinder potential.

It is confirmed from FIG. 6 that the experimental values of the amount of hydrogen to be stored are larger by about 20% at 77 K and by about 40% at 196 K than the values estimated by the GCMC method.

It is needless to say that this invention is not limited to the above examples but may be otherwise variously embodied in detail parts.

As explained above in detail, this invention provides a new self-locking carbon adsorbent that is useful, for example, for storing methane gas and can store various gases at room temperature in a quasi-liquid state.

1. A method of adsorption comprising passing a substance selected from the group consisting of methane and hydrogen through one or more openings provided in a wall part of a carbon-nanohorn aggregate forming a self-locking carbon adsorbent, wherein the substance passes through the one or more openings in one limited direction from the outside to the inside of the carbon nanohorn aggregate in isothermal or isobaric adsorption.

2. The method of claim 1, wherein the substance is a gas in a supercritical state and at room temperature.

3. The method of claim 2, wherein the substance is methane gas which is adsorbed in a quasi-liquid state on the inside of the carbon-nanohorn aggregate.

4. The method of claim 3, wherein the carbon-nanohorn aggregate has a structure such that it has a methane gas adsorption ability V/Vs, wherein V represents the volume of methane gas to be adsorbed and Vs represents the volume of the adsorbent, that is 150 or more at 303 K under a pressure of 3.5 MPa.

5. The method of claim 1, wherein the substance is methane gas which is adsorbed in a quasi-liquid state on the inside of the carbon-nanohorn aggregate.

6. The method of claim 5, wherein the carbon-nanohorn aggregate has a structure such that it has a methane gas adsorption ability V/Vs, wherein V represents the volume of methane gas to be adsorbed and Vs represents the volume of the adsorbent, that is 150 or more at 303 K under a pressure of 3.5 MPa.

7. The method of claim 1, wherein the adsorption takes place at a pressure of 0-12 MPa.
